(19) United States
(12) Patent Application Publication
(10) Pub. No.: US 2015/0285304 A1
(43) Pub. Date: Oct. 8, 2015

(54) BALL ROLLER BEARING

(71) Applicant: SCHAEFFLER TECHNOLOGIES AG & CO. KG, Herzogenaurach (DE)

(72) Inventors: Ernst Geiger, Hallerndorf (DE); Werner Wirth, Gerhardshofen (DE); Otmar Weber, Pommersfelden (DE); Robert Fackelmann, Furth (DE)

(73) Assignee: SCHAEFFLER TECHNOLOGIES AG & CO. KG, Herzogenaurach (DE)

(21) Appl. No.: 14/433,954

(22) PCT Filed: Sep. 18, 2013
(86) PCT No.: PCT/DE2013/200180

§ 371 Date: Apr. 7, 2015

(30) Foreign Application Priority Data
Oct. 10, 2012 (DE) 10 2012 218 409.0

(51) Int. Cl. F16C 33/38; F16C 33/44

(52) U.S. Cl. CPC F16C 33/3868; F16C 33/44

(57) ABSTRACT

A ball roller bearing (1) formed from a plurality of ball rollers (4) arranged between an outer bearing ring (2) and an inner bearing ring (3) and each of which comprises two parallel lateral surfaces (5, 6) and rolls, with their running surfaces (7) extending between said lateral surfaces (5, 6), in two groove-shaped raceways (10, 11) in an inner side (8) of the outer bearing ring (2) and the outer side (9) of the inner bearing ring (3), and which are held within individual cage pockets (12) of a bearing cage (13). The bearing cage (13) includes two interconnected lateral rings (15, 16) and two cage ribs which are connected thereto and in guiding contact with these lateral surfaces (5, 6) for axially guiding the ball rollers (4). The bearing cage (13) includes a cylindrical main part (17) having the lateral rings (15, 16) and pocket webs (14) and made of a cold-formable deep drawn steel, and the cage ribs are formed from two separate rib rings (18, 19) made of a thermally-treated carbon steel and are force and/or form-fittingly connected to the main part (17).

### FIELD OF THE INVENTION

The invention relates to a single row ball roller bearing which can be used, for example, in an especially advantageous way, as a fixed bearing for the drive shaft or driven shaft of a motor vehicle manual shift transmission.

### BACKGROUND

Ball roller bearings are anti-friction bearings with special rolling bodies that are constructed, starting from a basic ball shape, as ball rollers and have two lateral surfaces that are arranged parallel to each other and are flattened from this basic ball shape and between which the running surfaces of the ball rollers are arranged. Such ball roller bearings are generally known in a wide range of designs as single row, double row, triple row, or even quadruple row radial or inclined ball roller bearings and also require, due to the special rolling body shape, special cage designs, on one hand, to limit a maximum permissible axial tilting of the ball rollers relative to the vertical direction of the bearings and also, on the other hand, to prevent wobbling of the ball rollers perpendicular to their circumferential direction.

A class-forming, single-row ball roller bearing is known, for example, from DE 10 2009 042 076 A1 and consists essentially from an outer bearing ring and an inner bearing ring and also from a plurality of ball rollers that are arranged between these bearing rings and roll with their running surfaces in two groove-shaped raceways machined in the inner side of the outer bearing ring and in the outer side of the inner bearing ring and are held within individual cage pockets of a bearing cage in the circumferential direction at constant distances relative to each other. This bearing cage is formed with two lateral rings that are connected to each other by multiple profiled pocket webs and two cage ribs connected to these lateral rings and are bent by two circumferential flanged edges with reduced material thickness toward the inner bearing ring and are in guiding contact with their lateral surfaces for axial guidance of the ball rollers. For manufacturing such a bearing cage, a sheet metal strip made from a cold-formable deep drawn steel is usually used that is finished by profiling the cage rib, stamping the cage pockets, profiling the pocket webs, cutting to the circumferential dimension, rolling into a ring, and welding the ring ends.

In practice, however, it has been shown that the production of the bearing cage with the described shape is associated with special technical problems and the bearing cage also does not completely correspond qualitatively to the stated requirements. This relates primarily to the cage ribs profiled on the sheet metal strip, which are used to form a ring in the rolling of the cage for narrow material sections that are the reason that the cage ribs do not have a smooth, but instead a wavy surface. In addition, in the bearing operation, at the contact points of the lateral surfaces of the ball rollers with the cage ribs, increased wear occurs on the cage ribs due to material compression and abrasion so that the ball rollers are no longer properly guided on both sides in the axial direction and thus this leads to increased wobbling and lurching movements. These wobbling and lurching movements of the ball rollers can then lead to increased friction and increased bearing temperature resulting in increased bearing wear and finally to failure of the ball roller bearing.

### SUMMARY

Starting from the described disadvantages of the known prior art, the invention is based on the objective of designing a ball roller bearing whose bearing cage is structurally designed so that its cage ribs have smooth surfaces and a wear-resistant design.

According to the invention, this objective is addressed in a ball roller bearing according to the invention in which the bearing cage has a cylindrical main part consisting of lateral rings and pocket webs and made from a cold-formable deep drawn steel and the cage ribs are formed by two separate rib rings that are made from a heat treated carbon steel and are force and/or form-fittingly connected to the main part.

Preferred constructions and advantageous improvements of the ball roller bearing formed according to the invention are specified below and in the claims.

Accordingly, it is provided in an embodiment of the ball roller bearing formed according to the invention that the two separate rib rings have identical constructions and a V-shaped profile cross section in which a profile tab is constructed as a longer attachment tab by means of which the rib rings are connected to the main part of the bearing cage. In contrast, the other profile tab of the rib rings is constructed as a shorter stop tab that is arranged at an obtuse angle of approx. 150° relative to the attachment tab and forms an axial stop for the ball rollers.

According to another feature of the ball roller bearing formed according to the invention is that the attachment tab of the rib rings each have at the height of the pockets tabs of the main part, rectangular notches out of their outer circumference and are therefore each formed at the height of the cage pockets with tooth segments distributed uniformly around the circumference. The formation of the rib rings with such tooth segments and notches on their attachment tabs has proven advantageous to the extent that, due to the tooth segments, the elastic spring effect of the rib disks is increased for the guidance of the ball rollers and the lubricant distribution in the ball roller bearing is simultaneously improved by means of the notches.

A preferred improvement of the ball roller bearing formed according to the invention is that, in the inner diameter sides of the lateral rings of the main part, two circumferential grooves are formed in which the tooth segments of the rib rings can snap and that the free ends of the tooth segments of the attachment tabs are formed with sharp edges so that the rib rings can be prevented from independently falling out from the grooves in the lateral rings of the main body under load. The grooves are here preferably rolled into the pocket-side edge of the inner diameter sides of the lateral rings, while the sharp edges at the free ends of the tooth segments are produced by a subsequent cutting process.

Another feature of the ball roller bearing formed according to the invention is that the transition from the attachment tabs to the stop tabs of the rib rings is each formed by a rounding. The radial length of the attachment tab on each rib ring is here selected so that this rounding in the bearing operation is arranged exactly at the height of the rolling axes of the ball rollers and thus is in guiding contact exactly in the middle with their lateral surfaces. In this way, the longest possible linear contact between the rib rings and the ball rollers is achieved, by means of which the wobbling movements of the ball rollers are prevented in the circumferential direction.

In addition, the ball roller bearing formed according to the invention is distinguished in that an attachment tab of one rib ring and an attachment tab of the other rib ring are formed as stop surfaces for the lateral surfaces of the ball rollers for limiting a maximum permissible axial tilting of the ball rollers of approx. 15° on both sides of the vertical of the bearing. That means that, for an axial tilting of the ball rollers of 15° towards one or the other axial side, one lateral surface of each ball roller forms a surface area contact with the attachment tab of one rib ring and the other lateral surface of each ball roller forms a surface area contact with the stop tab of the other rib ring and thus prevents the ball rollers from falling out of their raceways.

Finally it is also provided as an advantageous construction of the ball roller bearing formed according to the invention that the rib rings of the bearing cage are made preferably from a carbon steel of type CK 45 M (DIN material no.: 1.1191) or CK 75 M (DIN material no.: 1.7222) and are produced without cutting by stamping pressing from a band material and subsequent hardening. These steel types are relatively economically unhardened spring steels that are often used in general mechanical and automotive engineering and are distinguished by high elasticity and good mechanical machining properties despite their high carbon content. It would also be conceivable, however, to produce the rib rings from other highly elastic spring steel types, for example, 38Si7 (DIN material no.: 1.5023) or 51CrV4 (DIN material no.: 1.8159), wherein, however, trade-offs would have to be made in terms of their mechanical machining.

In summary, the ball roller bearing formed according to the invention thus has the advantage relative to the ball roller bearings known from the prior art that it now has, instead of a one-part bearing cage, a three-part bearing cage using differential construction that is made from a cylindrical main part from a cold-formable deep drawn steel and from two separate rib rings from a heat-treated carbon steel. On one hand, this arrangement significantly simplifies the production of the bearing cage, because the main part no longer has profiled cage ribs that could result, in the rolling of the cage into a ring, in reduced material sections or cage ribs with wavy surfaces. On the other hand, the hardened rib rings guarantee that the bearing operation no longer leads to wear on the cage ribs at the contact points of the lateral surfaces of the ball rollers with the rib rings, as a result of which the ball rollers are no longer properly guided on both sides in the axial direction. In addition, the V-shaped profiling and the elasticity of the rib disks guarantee that the ball rollers are also closely guided in the load-free zone and are supported in the axial direction when entering and leaving the load zone and when pivoting at the respective pressure angle, so that wear-causing wobbling and lurching movements no longer occur or only to a slight degree.

### BRIEF DESCRIPTION OF THE DRAWINGS

A preferred embodiment of the ball roller bearing formed according to the invention is explained in more detail below with reference to the accompanying drawings. Shown are:

FIG. 1 an illustration of a cross section through a ball roller bearing formed according to the invention,

FIG. 2 an enlarged illustration of the detail X of the ball roller bearing formed according to the invention according to FIG. 1,

FIG. 3 a three-dimensional illustration of the main part of the bearing cage of the ball roller bearing formed according to the invention,

FIG. 4 a three-dimensional illustration of a rib ring of the bearing cage of the ball roller bearing formed according to the invention.

### DETAILED DESCRIPTION OF THE PREFERRED EMBODIMENTS

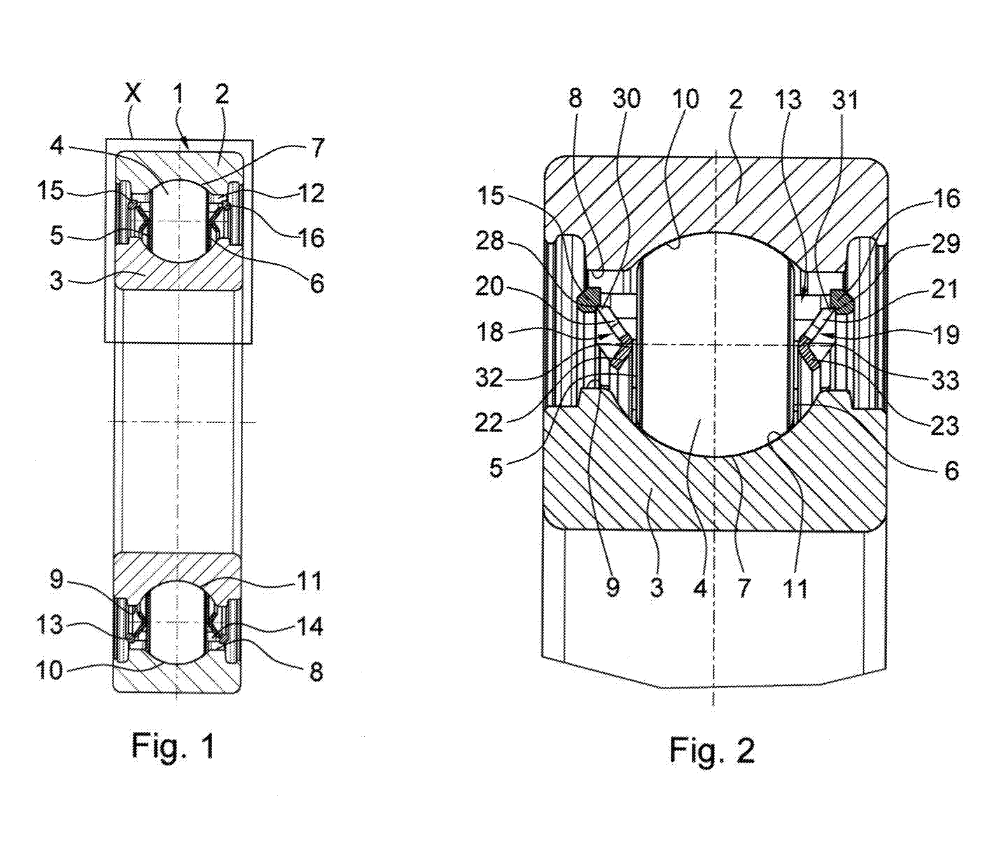

From FIGS. 1 and 2, a single row ball roller bearing 1 can be seen that is formed essentially from an outer bearing ring 2 and an inner bearing ring 3 and also from a plurality of ball rollers 4 that are arranged between these bearing rings 2, 3 and formed each with two parallel lateral surfaces 5, 6 flattened from a basic ball shape and roll with their running surfaces 7 running between the lateral surfaces 5, 6 in two groove-shaped raceways 10, 11 machined in the inner side 8 of the outer bearing ring 2 and in the outer side 9 of the inner bearing ring 3 and are held within individual pocket webs 12 of a bearing cage 13 in the circumferential direction at constant distances relative to each other. The bearing cage 13 here has two lateral rings 15, 16 connected to each other by several pocket webs 14 and two cage ribs that are connected to these lateral rings 15, 16 and point toward the inner bearing ring 3 and are in guiding contact with its lateral surfaces 5, 6 for axial guidance of the ball rollers 4.

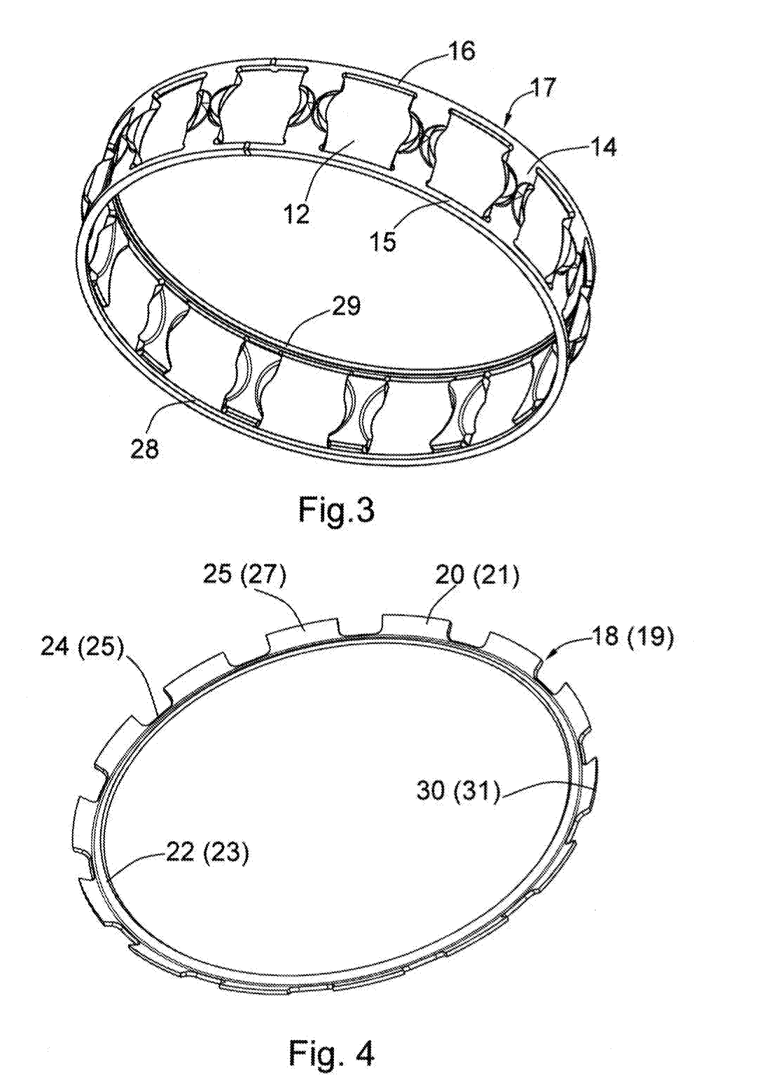

From FIGS. 3 and 4 it is clear that the bearing cage 13 of the ball roller bearing 1 has according to the invention, for simplifying its production and also for preventing wear on the cage ribs, a cylindrical main part 17 consisting of the lateral rings 15, 16 and the pocket webs 14 and made from a cold-formable deep drawn steel and the cage ribs are formed by two separate rib rings 18, 19 that are force and/or form-fittingly connected to the main part 17 as shown in FIG. 2. The two identically shaped separate rib rings 18, 19 produced without cutting by stamp pressing and then hardening here are formed of a carbon steel of type CK 45 M or CK 75 M and have a V-shaped profile cross section that is formed by a longer attachment tab 20, 21 and a shorter stop tab 22, 23 arranged at an obtuse angle of approx. 150° relative to the longer tab.

In addition, in FIGS. 3 and 4 it can be seen that the attachment tabs 20, 21 of the rib rings 18, 19 are formed by rectangular notches 24, 25 from their outer circumference each at the height of the pocket webs 14 of the main part 17 with tooth segments 26, 27 distributed equally around the circumference at the height of the cage pockets 12 and in the inner diameter sides of the lateral rings 15, 16 of the main part 17 there are two circumferential grooves 28, 29 in which the tooth segments 26, 27 of the rib rings 18, 19 can be snapped. The tooth segments 26, 27 here increase the elastic spring effect of the rib rings 18, 19 for the guidance of the ball rollers, while the notches improve the lubricant distribution in the ball roller bearing 1. In addition, the free ends of the tooth segments 26, 27 of the attachment tabs 20, 21 are formed with sharp edges 30, 31 with which the rib rings 18, 19 are prevented from independently falling out from the grooves 28, 29 in the lateral rings 15, 16 of the main part 17 under load.

Finally it can be seen from FIG. 2 that the transition from the attachment tabs 20, 21 to the stop tabs 22, 23 of the rib rings 18, 19 is formed by a rounding 32, 33 that is in guiding contact in the bearing operation at the height of the roller axes of the ball rollers 4 with their lateral surfaces 5, 6 and thus guarantees the longest possible linear contact between the rib rings 18, 19 and the ball rollers 4, by means of which the wobbling movements of the ball rollers 4 in the circumferential direction are prevented. In FIG. 2 it is also shown that each attachment tab 20 or 21 of one rib ring 18 or 19 and an attachment tab 22 or 23 of the other rib ring 19 or 18 is formed as a contact surface for the lateral surfaces 5, 6 of the ball rollers 4 and is provided for limiting a maximum permissible axial tilting of the ball rollers 4 by approx. 15° on both sides of the vertical for the bearing. For an axial tilting of the ball rollers of 15° to one axial side, the lateral surface 5 of each ball roller 4 forms a surface area contact with the attachment leg 21 of the rib ring 19 and the lateral surface 6 of each ball roller 4 forms a surface area contact with the stop tab 22 of the rib ring 18 or for an axial tilting of the ball rollers of 15° to the other axial side, the lateral surface 5 of each ball roller 4 forms a surface area contact with the attachment leg 20 of the rib ring 18 and the lateral surface 6 of each ball roller 4 forms a surface area contact with the stop tab 22 of the rib ring 19 and thus prevents the ball rollers 4 from coming out of their raceways 10, 11.

### LIST OF REFERENCE NUMBERS

| | |
|---|---|
| 1 | Ball roller bearing |
| 2 | Outer bearing ring |
| 3 | Inner bearing ring |
| 4 | Ball rollers |
| 5 | Lateral surfaces of 4 |
| 6 | Lateral surfaces of 4 |
| 7 | Running surfaces of 4 |
| 8 | Inner side of 2 |
| 9 | Outer side of 3 |
| 10 | Raceway in 8 |
| 11 | Raceway in 9 |
| 12 | Cage pockets in 13 |
| 13 | Bearing cage |
| 14 | Pocket webs of 13 |
| 15 | Lateral ring of 13 |
| 16 | Lateral ring of 13 |
| 17 | Main part of 13 |
| 18 | Rib ring on 13 |
| 19 | Rib ring on 13 |
| 20 | Attachment tab of 18 |
| 21 | Attachment tab of 19 |
| 22 | Stop tab of 18 |
| 23 | Stop tab of 19 |
| 24 | Notches in 20 |
| 25 | Notches in 21 |
| 26 | Tooth segments on 20 |
| 27 | Tooth segments on 21 |
| 28 | Groove in 15 |
| 29 | Groove in 16 |
| 30 | Sharp edges on 26 |
| 31 | Sharp edges on 27 |
| 32 | Rounding on 18 |
| 33 | Rounding on 19 |

1. A ball roller bearing, comprising: an outer bearing ring and an inner bearing ring, and a plurality of ball rollers arranged between the inner and outer bearing rings each of the ball rollers having two parallel lateral surfaces that roll with their running surfaces that extend between the lateral surfaces in two groove-shaped raceways machined into an inner side of the outer bearing ring and into an outer side of the inner bearing ring and are held within individual cage pockets of a bearing cage in a circumferential direction at constant distances relative to each other, the bearing cage has two lateral rings connected to each other by several pocket webs and two cage ribs that are connected to said lateral rings and point toward the inner bearing ring and are in guiding contact via with the lateral surfaces for axial guidance of the ball rollers, the bearing cage further comprising a cylindrical main part including the lateral rings and the pocket webs made from a cold-formable deep drawn steel, and the cage ribs are formed by two separate rib rings made from a heat-treated carbon steel and are at least one of force or form-fittingly connected to the main part.

2. The ball roller bearing according to claim 1, wherein the two separate rib rings have identical constructions and a V-shaped profile cross section each with a longer attachment tab and a shorter stop tab that are arranged at an obtuse angle of approx. 150° relative to each other.

3. The ball roller bearing according to claim 2, wherein the attachment tabs of the rib rings are formed by rectangular notches out of an outer circumference each at a height of the pocket webs of the main part with tooth segments distributed uniformly around the circumference at a height of the cage pockets.

4. The ball roller bearing according to claim 3, wherein two circumferential grooves in which the tooth segments of the rib rings are snapped are formed in inner diameter sides of the lateral rings of the main part.

5. The ball roller bearing according to claim 4, wherein free ends of the tooth segments of the attachment tabs are formed with sharp edges for preventing the rib rings from independently falling out from the grooves into the lateral rings of the main part under load.

6. The ball roller bearing according to claim 2, wherein the transition from the attachment tabs to the stop tabs of the rib rings is formed by a rounding that is in guiding contact with its lateral surfaces during bearing operation at a height of roller axes of the ball rollers.

7. The ball roller bearing according to claim 6, wherein each of the attachment tabs of one of the rib rings and each of said stop tabs of the other rib ring is constructed as a stop surface for the lateral surfaces of the ball rollers for limiting a maximum permissible axial tilting of the ball rollers of approx. 15° on both sides of a vertical of the bearing.

8. The ball roller bearing according to claim 6, wherein the rib rings of the bearing cage are formed of a carbon steel of type CK 45 M (DIN material no.: 1.1191) or CK 75 M (DIN material no.: 1.7222) and are stamp pressed from a band material and hardened.
